(19) United States
(12) Patent Application Publication
(10) Pub. No.: US 2016/0275571 A1
(43) Pub. Date: Sep. 22, 2016

(54) PACING THE SERVING OF A CONTENT ITEM

(71) Applicant: LINKEDIN CORPORATION, Mountain View, CA (US)

(72) Inventors: Zhifeng Deng, Mountain View, CA (US); Siyu You, Santa Clara, CA (US); Dakan Wang, Mountain View, CA (US)

(73) Assignee: LINKEDIN CORPORATION, Mountain View, CA (US)

(21) Appl. No.: 14/663,116

(22) Filed: Mar. 19, 2015

(51) Int. Cl. G06Q 30/02

(52) U.S. Cl. CPC G06Q 30/0275; G06Q 30/0206

(57) ABSTRACT

A system, method, and apparatus are provided for pacing the serving of a sponsored content item. The rate of depletion of the sponsored content item, or the current rate at which it wins auctions to be served in response to compatible content requests is used to forecast the state of the item's periodic budget at the end of a current period. If the budget is not forecast to be depleted close to the end of the period, within a threshold measure of value or time, a new win rate that will accomplish the goal is determined. Based on past performance, which may be represented as a collection of estimated costs per impression (eCPI) or as ratios of the item's eCPI to a winning item's eCPI, a new bid can be determined that is estimated to yield the new win rate.

### BACKGROUND

This disclosure relates to the field of computer systems. More particularly, a system, apparatus, and method are provided for pacing the serving or of an electronic content item.

A sponsored electronic content item incurs a cost to the item's sponsor each time one or more impressions, copies or versions of the item are served or delivered to one or more users. The sponsor may control the extent of these charges by setting a periodic budget that limits how much it may be charged during the corresponding period.

However, some content providers that serve sponsored content items do not attempt to control the rate or pace at which a sponsored item is served, or do not do so efficiently. A result can be that the sponsor's budget may be expended relatively early in the period and the sponsor's item may not reach users who are most interested in the item, but who are not active early in the budget period.

### DESCRIPTION OF THE FIGURES

FIG. 1 is a block diagram depicting an environment in which the serving of an electronic content item is paced, in accordance with some embodiments.

FIG. 2 is a flow chart illustrating a method of pacing the serving of an electronic content item, in accordance with some embodiments.

FIG. 3 illustrates the use of a graph to determine whether to adjust the serving of an electronic content item, in accordance with some embodiments.

FIG. 4 depicts an apparatus for pacing the serving of an electronic content item, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, method, and apparatus are provided for pacing the serving of a sponsored item of electronic content, which may comprise textual, graphical, audio, video, and/or other content. In these embodiments, pacing the serving of the item involves adjusting the frequency or rate at which it is served, or is likely to be served, so as to allow or facilitate expenditure of the item's periodic budget over some, most, or all of the corresponding period (e.g., a day). More particularly, adjusting the pacing of the item may affect how often it wins, or can be expected to win, auctions or other competitions conducted to determine which of multiple available content items to serve in response to a content request.

In these embodiments, the sponsored content item participates in virtually all auctions/competitions for which it is eligible or compatible. Content requests typically identify characteristics of compatible content items, or provide attributes of a target user or audience to whom the selected content will be served, which may be used to identify compatible content items. Thus, the sponsored content item usually is merely one of multiple items that are compatible with a given content request and that are therefore candidates for being served to one or more users in response to the request.

By effectively pacing the serving of the sponsored content item as described herein, while enabling the item to participate in virtually all auctions for which it is eligible, the content item can reach members of a target audience throughout the budget period. This contrasts with a system or method that allows a given content item's periodic budget to be exhausted relatively rapidly, during only a fraction of the budget period for example.

In embodiments described herein, effective pacing of a sponsored content item is achieved by automatically altering a bid associated with the item, which at least in part determines which of multiple candidates win the competition conducted to select a content item to serve in response to a given content request, and therefore affects the rate or frequency with which it may be expected to win auctions. One of ordinary skill will recognize that this technique differs from schemes that instead alter the probability of a given content item participating in a given auction without adjusting its bid, and from schemes that may temporarily prevent a given content item from participating in auctions.

In some implementations, the sponsored content item's bid is not increased beyond an initial bid or a maximum bid (e.g., as set by the item's sponsor), or not increased to the point that the item's average bid (or average winning bid) exceeds an initial or maximum bid. Similarly, in some implementations the item's bid is not decreased below an initial bid or minimum (e.g., floor) bid, or not decreased to the point that the average bid is below an initial or minimum bid.

By allowing the sponsored content item to participate in (virtually) all auctions associated with content requests with which the item is compatible, the overall auction process continues to receive support from virtually all sponsored content items. In contrast, the auction process would lose price support if one or more compatible content items did not participate. This could cause lower-value content items to win auctions and/or reduce revenues derived from serving sponsored content.

As described below, pacing the serving of a sponsored content item in some embodiments occurs during multiple time intervals throughout a budget period (e.g., intervals of 3 minutes, 5 minutes, or 15 minutes within a daily period). In some implementations, for each auction in which the item participates, the ratio is calculated between the estimated cost of serving the sponsored content item and the estimated cost of serving whichever content item won the auction. This ratio will be 1 for each auction the item wins, and generally less than 1 for each auction it does not win. Ratios, estimated costs, and/or actual bids associated with the content item may be recorded. In particular, for some or all auctions, the estimated cost (to the sponsor) of serving whichever content item won the auction may be noted, which may be referred to as the “winning estimated cost” or something similar.

During each time interval, winning estimated costs and/or ratios for some or all auctions in which the item participates may be combined, possibly as a collection of individual values (e.g., if the number of auctions is less than a threshold) or as a probability distribution (e.g., a normal or log-normal distribution) of the values. This distribution may reveal a density of the estimated costs or estimated cost ratios during the interval, and may, as described below, assist in determining how much to adjust the item's bid in order to pace it.

Based on the rate at which it is winning auctions, the current rate at which the item is being served, or the rate at which its periodic budget is being depleted, any of which may illustratively be represented in terms of cost to the item's sponsor per unit of time (e.g., $X per interval, $Y per hour), and a remaining portion of the item's periodic budget, a calculation is made as to whether the item's periodic budget will be fully expended at the end of the budget period.

If it is determined that continuation of the current win rate (or serving rate or rate of budget depletion) will not result in full expenditure of the budget close in time with the end of the budget period, possibly within suitable margins in terms of time and/or value, a new rate that will result in full expenditure at or close to the end of the budget period is determined. The estimated cost ratios and/or winning estimated costs combined during the current interval, and/or other information (e.g., historical bids, a histogram identifying how many auctions are won with different bids or costs) are then examined to determine or identify a bid or bid adjustment that will likely yield the new rate. That bid is then used during one or more subsequent intervals. The calculations necessary to identify/adjust a bid may be performed every interval or with some other regular or irregular frequency.

Embodiments of pacing are described below as they may be implemented in association with a single sponsored content item having a corresponding periodic budget and an associated bid that may be adjusted during a budget period. One of ordinary skill in the art will appreciate, however, that a budget may apply to a campaign comprising any number of sponsored content items (i.e., one or more), which may have the same or different associated bids at any given time. Other embodiments of pacing suitable for simultaneous application with multiple content items in a single campaign may be derived from the following.

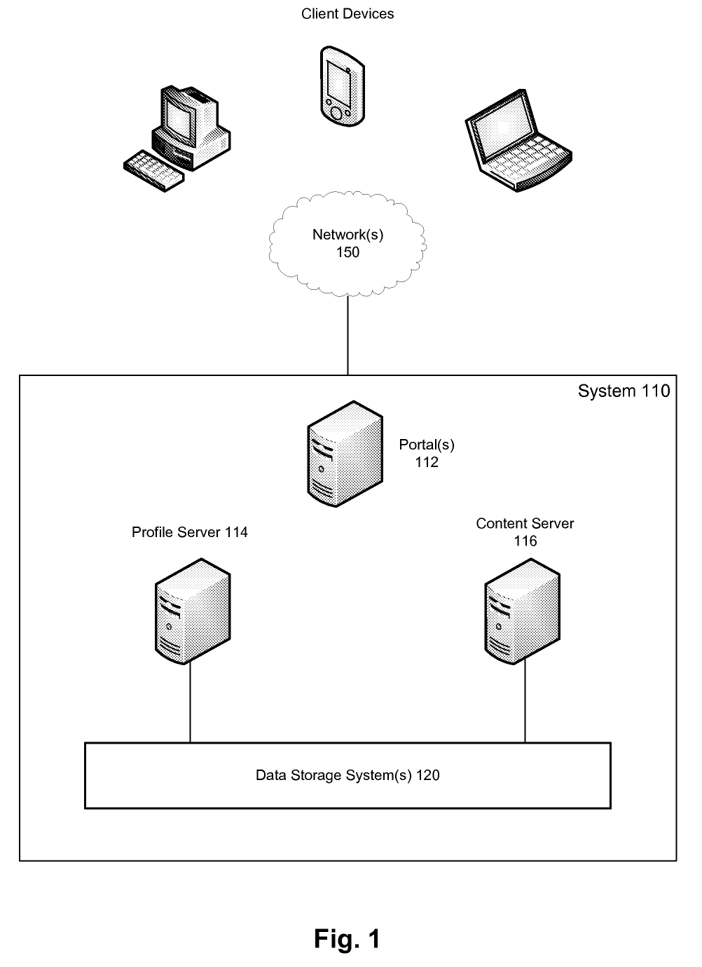

FIG. 1 is a block diagram depicting an environment in which the serving of a sponsored electronic content item is paced, according to some embodiments.

System 110 of FIG. 1 is (or is part of) a data center that supports or hosts an online application or service that serves content to users, including sponsored content items for which sponsors pay an operator or provider of system 110. In some specific implementations, the application or service is a professional network or a social network. Users of system 110 may be termed members because they may be required to register with the system in order to use the application or service. Members may be identified and differentiated by username, electronic mail address, telephone number, and/or some other unique identifier.

Sponsored content served to members from system 110 may include any type or format of information a sponsor would like to have served, and may include job opportunities, media (e.g., songs, video), multi-media compilations, advertisements, and so on.

Users/members of a service or services hosted by system 110 connect to the system via client devices, which may be stationary (e.g., desktop computer, workstation) or mobile (e.g., smart phone, tablet computer, laptop computer). In order to interact with the system (e.g., to view content, submit or edit content) the client devices operate suitable client applications, such as a browser program or an application designed specifically to access a service offered by system 110.

Client devices are coupled to system 110 and receive content served by the system via direct channels and/or shared channels, such as network(s) 150, which may include the Internet, intranets, and/or other networks, and may incorporate wired and/or wireless communication links.

Interactive user/member sessions are generally made through portal(s) 112, which may comprise an application server, a web server, and/or some other gateway or entry point. The portal through which a given session is established may depend on the member's device or method of connection. For example, a user of a mobile client device may connect to system 110 via a different portal (or set of portals) than a member operating a workstation or desktop computer. Similarly, content served to a member or user may be served in any format or style suitable for the device operated by the member.

System 110 also includes profile server 114, content server 116, and data storage system(s) 120, which may comprise a distributed data storage system. Data storage system(s) 120 and/or components of the data storage system (e.g., separate storage engines) include appropriate data storage devices (e.g., disks, solid-state drives).

Profile server 114 maintains profiles of members of the service(s) hosted by system 110, which may be stored in data storage system(s) 120 and/or elsewhere, such as a profile database coupled to the profile server. An individual member's profile may include or reflect any number of attributes or characteristics of the member, including personal (e.g., gender, age or age range, interests, hobbies, member ID), professional (e.g., employment status, job title, employer or associated organization, industry, functional area or role, skills, endorsements, professional awards), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify who sent a message, to identify a recipient of a status update, to select content to serve to the member or an associated member, to record a content-delivery event). Some or all profile data of a member may be retained permanently or for a long period of time.

Organizations may also be members of the service (i.e., in addition to individuals), and may have associated descriptions or profiles comprising attributes such as industry (e.g., information technology, manufacturing, finance), size, location, goal, etc. An organization may be a company, a corporation, a partnership, a firm, a government agency or entity, a not-for-profit entity, a group or collection of associated members, or some other entity formed for virtually any purpose (e.g., professional, social, educational). Either or both organizations and individual members may “follow” and/or be followed by other members.

Content server 116 serves content to members, or manages the serving of content to users by system 110, wherein the content includes sponsored content items. Content served to users may be stored in data storage system(s) 120 and/or elsewhere, such as one or more content repositories or databases coupled to the content server.

Content server 116 may also maintain an index of content items available for serving, records of what has been served to whom, and when, and/or other information related to or involved in serving content to members. Illustratively, content server 116 may serve on the order of hundreds of millions of items every day. Content server 116 may include a recommendation module for recommending content to serve to a member, or recommendations may be generated by some other component of system 110 (which may not be depicted in FIG. 1).

System 110 may include other components not illustrated in FIG. 1. For example, in some embodiments, system 110 includes a tracking server that monitors and records activity of system 110 and/or members regarding what is served, to whom (e.g., which member), and when it was served, and that may receive notifications of member actions regarding content. Information captured by such a tracking server may or may not duplicate information maintained by content server 116.

As another example, system 110 may include a graph server that maintains a graph representing the user/member community or communities that make use of services offered by system 110. The graph may be stored within data storage system 120 and/or elsewhere. Within the graph, nodes represent members (either or both individual members and organizations) and are coupled to other nodes via edges. Nodes have attributes (and values for those attributes) corresponding to the members they represent (e.g., attributes extracted from the members' profiles), and an edge may also have attributes related to the connection it represents between two members (e.g., when the members were connected, how they were connected, a strength of the connection). The network of members of a service offered by system 110 may illustratively number in the tens or hundreds of millions.

Content items served or published by system 110 may include content generated by members and/or content supplied by third parties. Such content may include postings, messages, advertisements, offers, announcements, job listings, news, informative articles, member activities, and so on, and may be or may include any type of media (e.g., text, graphics, image, video, audio).

Members of a service hosted by system 110 have corresponding pages on the system (e.g., web pages, content pages), which they may use to facilitate their activities with the system and with each other, to form connections/relationships with other members, to view their connections and/or information regarding their connections, to review their profiles, to inform friends and/or colleagues of developments in their lives/careers, to receive/view sponsored content items, etc. These pages (or information provided to members via these pages) are available to some or all other members. Members' pages may be stored within data storage system 120 or elsewhere.

Functionality attributed herein to system 110 may be distributed among its components in a manner other than that described above, such as by merging or further dividing functions of one or more components, or may be distributed among a different collection of components. Yet further, while depicted as separate and individual hardware components (e.g., computer servers) in FIG. 1, one or more of portal(s) 112, profile server 114, and content server 116 may alternatively be implemented as separate software modules executing on one or more computer servers. Thus, although only a single instance of a particular component of system 110 may be illustrated in FIG. 1 or referred to herein, it should be understood that multiple instances of some or all components may be utilized.

In some embodiments, a sponsored content item is received (e.g., from a sponsor) along with a budget applicable to a recurring time period (e.g., hour, day, week). A periodic budget indicates the maximum amount of value (e.g., money) the sponsor will pay for the sponsored content item during the period—in other words, the maximum cost the sponsor will be assessed and spend for serving the item during the period.

One or more bids are also received with the item, which may include an initial bid, a maximum bid, a minimum bid, etc. An initial bid may be adopted as the initial “current” bid for the auctions in which the item competes, which subsequently may be adjusted during a budget period, as described herein for example. Generally, an item's current bid will not exceed any applicable maximum and will not fall below a minimum, unless perhaps the maximum and/or minimum apply to averages of the item's bids, instead of individual bids, in which case a given bid may be greater than the maximum or less than the minimum.

When a request for sponsored content is received, such as when a web page, form, message, or other document is to be presented to a user and one or more sponsored content items are to be served with the document, each sponsored item that is compatible with the request (e.g., based on attributes of the user and/or characteristics of the items' target audiences) will participate in an auction or other competition to determine which item or items are served. The competition may depend primarily upon the current bids of the participating content items.

An item's current bid represents the cost to the item's provider for serving one or more impressions of the item. More specifically, a current bid for a sponsored content item that is to be served on a cost-per-click (or CPC) basis represents the cost of serving one impression of the item that a user clicks on. In contrast, a current bid for a sponsored content item that is served on a cost-per-mille (CPM) basis represents the cost of serving multiple (e.g., 1,000) impressions of the item. Some items may be served on other bases, such as cost-per-action (CPA), and incur corresponding costs for their sponsors.

A sponsored content item's current bid may be used to calculate an estimated cost per impression or eCPI, which for a content item served on a cost-per-click basis will be its current bid multiplied by the predicted or forecasted click-through rate (pCTR), or eCPI*pCTR. For a content item served on a cost-per-mille basis, eCPI is the current bid multiplied by 0.001. For a content item served on a cost-per-action basis, eCPI is the current bid multiplied by the action rate (i.e., the rate at which the target action occurs or is predicted or estimated to occur).

As a sponsored content item is served during a budget period, an apparatus or system that performs or supports the serving of content (e.g., content server 116 or system 110 of FIG. 1) may track the portion of the item's budget that has been expended or depleted. For example, a value representing the accumulated expenditures or costs may be incremented for each expenditure or cost associated with serving the item (e.g., each time it wins an auction, each time the item is served) and compared with the total periodic budget. Or, a value representing the remaining balance or unspent portion of the budget may be decremented each time a portion of the budget is spent or allocated, until it reaches zero.

A goal of some embodiments of pacing described herein is to fully expend a sponsored item's budget at or near the end of its budget period, so that the item competes to be served throughout the full term of the period, or at least a majority of the full term. It may also be desirable to serve the content item at a rate or pace that is similar to the rate or pace at which compatible content requests are received.

A compatible content request, with regard to a particular sponsored content item, is a request for content that includes or is associated with parameters that match the content item. Thus, assuming the request identifies one or more attributes of a user to whom content will be served, the item is compatible if characteristics of the content item (or the content item's target audience) match or overlap those attributes, or if the item is otherwise a candidate for serving in response to the request.

To provide for regular (or irregular) opportunities to determine whether the serving of a given sponsored content item is proceeding at a pace or rate that should fully deplete its budget close to the end of the budget period, the period may be divided into multiple intervals of the same or different duration. The entire period may be divided into intervals of equal size (e.g., 3 minutes, 5 minutes, 15 minutes), or different portions of the period may be divided into differently sized intervals. For example, during a portion of the period in which many compatible requests for content are expected, intervals may be relatively short in duration, while longer intervals may be used during a portion of the period in which fewer compatible requests are expected.

During some or all intervals, a content server that serves sponsored content item, or a tracking server, a budget server, or other entity involved in serving sponsored content items and/or monitoring depletion of their budgets, will determine whether the item's budget will be depleted at or very near the end of the budget period. This determination may be based on the current rate of depletion of a sponsored content item's budget, the current rate of serving the item, the rate at which it wins auctions (e.g., its win rate), and/or other information.

If it is estimated that the budget will be exhausted more than a threshold amount of time before the end (e.g., one time interval, 15 minutes) or that more than a threshold amount of the budget would be left unexpended at the end of the period (e.g., 1% of the budget, $0), then a new rate of budget expenditure, a new rate at which the content item should be served in response to compatible content request, or a new win rate, will be computed.

In embodiments described herein, the sponsored content item's win rate (or other rate indicative of or related to expenditure of its budget) is altered by adjusting the item's bid for the auctions in which it participates, subject to any applicable maximum and/or minimum bids (or maximum/minimum average bids). To help determine a new or adjusted bid, for some or all auctions (e.g., during the current time interval, for some predetermined amount of time) the estimated cost per impression of the winner of the auction is recorded (e.g., the “winning eCPI”). In some implementations, multiple eCPI values will be recorded for an auction, such as the eCPIs of the top X (X≧2) bids.

Some or all of these winning eCPI values are aggregated or combined. Subsequently, if the win rate of the sponsored content item is to be adjusted, the combined values will be used to calculate a bid that is likely to provide the desired rate. For example, if it is determined that its win rate needs to be increased (or decreased) by 20% in order for the item's periodic budget to be depleted close to the end of the budget period, the combined eCPI values and/or other information may be used to identify a higher (or lower) eCPI or bid, or an adjustment to apply to the current bid, that would likely yield the desired change in win rate.

In different implementations, aggregating or combining eCPIs may involve simply collecting the values as discrete data points, calculating a normal or log-normal distribution, determining a probability density (e.g., that a given eCPI) will win an auction, and/or some other action.

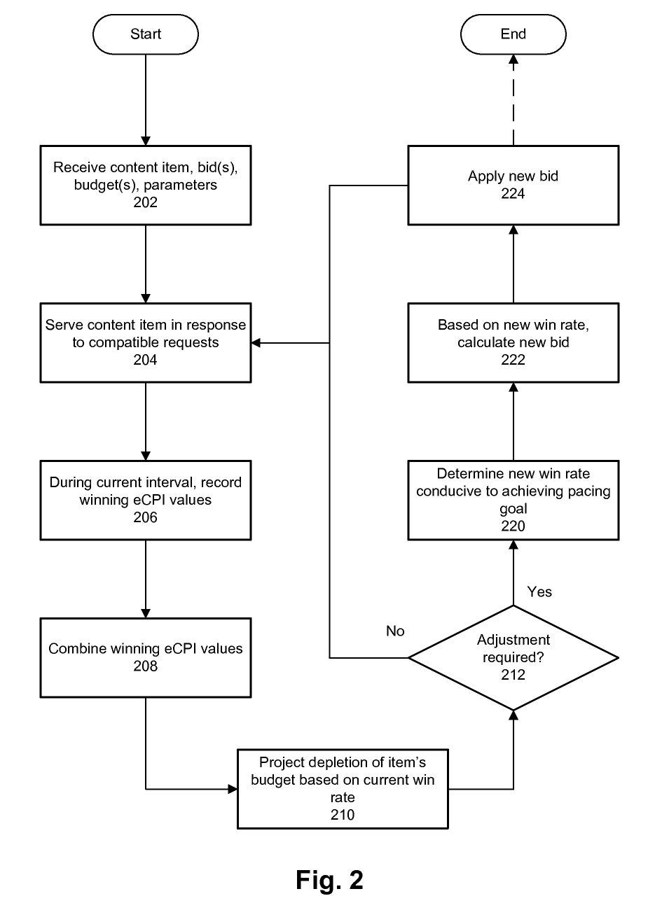

FIG. 2 is a flow chart illustrating a method of pacing the serving of a sponsored content item, according to some embodiments. In different embodiments, one or more of the operations may be omitted, repeated, and/or performed in a different order. Accordingly, the specific arrangement of steps shown in FIG. 2 should not be construed as limiting the scope of the embodiments discussed herein.

In operation 202, a sponsored content item is received (e.g., from a sponsor), along with applicable bids and bid restrictions (e.g., an initial current bid, a maximum, a minimum), and parameters that will be used to identify content requests with which the item is compatible. For example, the parameters may include a set of characteristics that identify or reflect a target audience to whom the sponsor would like the item served. The item will therefore be compatible with content requests that seek content that will be served to users having corresponding attributes.

Also in operation 202, a current bid is configured and a corresponding estimated cost per impression (eCPI) for serving the item is calculated. The current bid may match an initial bid set by the sponsor, may be copied from a current bid of the item at the end of a previous budget period, or may be derived or set in some other manner. The estimated cost per impression may be determined as described above for items served on a CPC-, CPM- or CPA-basis. If the item is served on some other basis, the estimated cost per impression will be determined appropriately.

In operation 204, a content-serving system such as system 110 of FIG. 1 begins serving the sponsored content item as one of a multitude of items. In some implementations, operation 204 may mark the beginning of a new budget period (e.g., a day) and/or a new time interval within a budget period.

Each time the content item is served as a sponsored item, the cost (to the sponsor) of serving the item, which may alternatively be viewed as revenue to the system that served the item, is used to update the status of the item's budget. Illustratively, these aggregated costs may be referred to as accumulated expenditures, an accumulated spent portion of the budget, accumulated costs, or something similar. Alternatively, a portion of the budget that remains (i.e., that has not yet been expended or spent) may be tracked and referred to as a remaining budget, unspent budget, or something similar.

Thus, in the illustrated method, after a new budget period commences for the sponsored content item, a measure of accumulated expenditures is increased each time one or more impressions of the item are served. In some implementations, each increase may be equivalent to the estimated cost per impression of the item. In some other implementations, it may be the actual cost of serving one impression, after that impression is served (e.g., on a CPC basis), or the actual cost of serving multiple impressions (e.g., on a CPM basis) before or after the multiple impressions are served.

In operation 206, for each auction, the eCPI of the winning item is recorded (and possibly the eCPI of the item itself, if it did not win). The actual bid corresponding to the item's eCPI can be easily derived from the eCPI if needed, or may also be stored. In some implementations, instead of storing winning eCPI values for every auction, they are stored just for auctions in which the sponsored content item participates or for auctions associated with compatible content requests.

In operation 208, during or at the end of the current time interval, the winning estimated costs per impression stored in operation 206 are combined in some manner. In some implementations, such as when the total number of eCPI values or total number of auctions for which winning eCPIs were stored is less than some threshold or cut-off (e.g., 100, 500, 1,000, 5,000), which may depend on the duration of the time interval, the values are simply assembled as a list, histogram, or other collection of discrete data values. This collection may be visualized as a probability distribution illustrating winning eCPIs observed during the current time interval.

In some other implementations, such as when the total number of eCPI values or total number of auctions for which winning eCPIs were stored exceeds the threshold or cut-off, a distribution (e.g., a normal distribution, a log-normal distribution, a density distribution) is generated to represent them. To generate a distribution, the mean (μ) and standard deviation (σ) may be computed from the collected values. After they are computed once, they may be re-computed each time a new winning eCPI is stored, without having to retain the values. For example, a running total representing the sum of all winning eCPI values (e.g., values observed during the current time interval) may be maintained, along with a count of auctions for which winning eCPIs were stored; this allows an updated mean value for μ to be computed each time the item participates in another auction or each time another auction is conducted.

Based on the normal mean μ and normal standard deviation σ of collected winning eCPI values, a normal distribution can be denoted as N(μ, σ). For a log-normal distribution, log-normal mean

$$M = {e}^{( μ + \frac{{σ}^{2}}{2} )} ,$$

and log-normal standard deviation S=\sqrt{(e^{σ}^{²}−1)×e^{2μ+σ}^{²}}.

Illustratively, maximum likelihood estimation (MLE) may be applied to the collected eCPI values. The sum of the (natural) logs of observed values is tracked (as Σ ln(x), wherein x represents an observed winning eCPI) and also the sum of the squares of the (natural) logs of observed winning eCPI values (Σ ln(x)²). Therefore, x˜ln N(μ, σ²), where

$$μ = \frac{\sum ln ( x )}{n}$$

and σ²=(Σ ln(x))²−Σ ln(x)²/n−1.

In yet other implementations, a histogram of winning eCPI values is maintained. In these implementations, for each eCPI value that won an auction (e.g., during the current interval or a recent interval), the histogram provides a corresponding density or measure of how often the corresponding bid triumphed.

Collection of winning eCPI values may restart with each interval, every X intervals (X≧2), or with some other regularity. In the illustrated method, for example, after one interval's values are used as described below to adjust a bid or select a new bid, the collected data are discarded and a new collection begun with the next interval.

However, if a given sponsored content item participates in relatively few auctions, a collection of winning eCPIs may persist for a longer period of time. For example, a rolling window covering some time period or some number of auctions' winning estimated costs.

In operation 210, based on the current rate at which the sponsored content item wins auctions in which it participates (e.g., its win rate), its current estimated cost per impression, its budget, the accumulated expenditures, and/or other factors, a projection or forecast is generated regarding depletion of the item's budget. In some implementations, for example, the forecast involves assuming that the win rate remains constant and that the bid does not change, and determining when the budget will be depleted or whether it will be depleted at the end of the budget period.

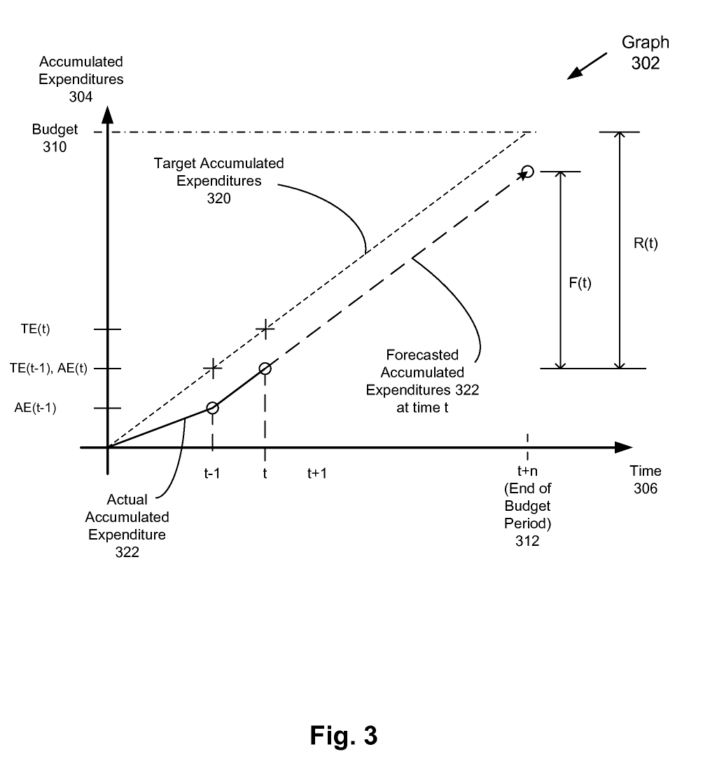

FIG. 3 is a graph illustrating such a forecast, according to some embodiments. The y- and x-axes of graph 302 represent accumulated expenditures 304 associated with serving the sponsored content item and time 306, respectively. Full exhaustion of the item's period budget 310 is a goal, preferably close in time to the end of the budget period 312.

Curve 320 represents the target accumulated expenditures over the course of the budget period. Although curve 320 reflects a constant target rate of expenditures from the beginning of the budget period to the end, in other embodiments the target rate of expenditures is not constant.

For example, it may attempt to match the rate or frequency at which compatible content requests are received, in which case the shape of curve 320 would approximate or match a curve reflecting the rate of receipt of compatible content requests.

The initial portion of curve 322 (e.g., up to current time index t) represents the actual accumulated expenditure of the item's budget 310, and grows over the course of the budget period. After time t, (i.e., for the future portion of the current budget period), curve 322 is a forecast.

Curve 322 lags curve 320 in the scenario depicted in FIG. 3, meaning that actual expenditure of the sponsored content item's budget is lower than the target expenditure. For example, the actual expenditure as of time t−1, represented as AE(t−1) is lower than the target expenditure as of time t−1, represented as TE(t−1), and a similar situation exists at time t.

Time indices (e.g., t, t−1, t+1) are associated with separate, consecutive time intervals of the budget period, and may mark the beginning, the mid-point, the end, or some other point within each interval. In the currently discussed method associated with the flow chart of FIG. 2, each time index identifies the end of a time interval, which is when the forecasts, win rates, and bid adjustments described herein may be computed, and/or other calculations may be made. Forecasts, win rates, bid adjustments and/or other calculations may occur at other points in other implementations.

Thus, at time t, based on a current win rate of the content item and the expected resulting rate of expenditure of the item's budget, indicated by curve 322, the total amount of the budget that would be expended by the end of the budget period 312 is less than budget 310, by more than an insignificant amount. The current win rate may illustratively be calculated by dividing the number of times the sponsored content item has won an auction (e.g., in the current time interval, multiple intervals, a set time period, overall in the current budget period) by the number of auctions in which it participated (e.g., during the current time interval, set time period, or overall), which may be multiplied by 100 to yield a percentage.

In some implementations, values depicted as F(t) and R(t) are calculated. F(t) represents the additional budget expenditures forecasted to occur if the content item's current win rate at time t continues unaltered, and R(t) represents the portion of the item's budget that remains unspent as of time t.

Returning to the method illustrated in FIG. 2, in operation 212 a determination is made as to whether any adjustment to the content item's win rate is required in order to achieve the goal of depletion of the item's budget close in time to (or at) the end of the budget period.

The budget depletion projected in operation 210, for the illustrative scenario of FIG. 3, for example, indicates that this goal will not be satisfied. In particular, a significant portion of the budget remains unspent. This unspent remainder can be calculated as R(t) minus F(t).

In some implementations, if the unspent budget that remains at the end of the budget period is insignificant or less than a threshold (e.g., 1%, 5%, 10%), or if the forecast indicated that the budget would be fully depleted within a minor increment of time after the budget period ended (e.g., less than one time interval), no adjustment may be warranted.

Similarly, however, if the item's budget 310 was projected to be fully depleted more than a threshold period of time before the end of the budget period 312 (e.g., one or more time intervals), an adjustment may be deemed required. Early projected depletion of the budget may be indicated by curve 322 crossing curve 320 before time t+n.

If no adjustment to the content item's win rate is deemed necessary, because the forecasted accumulated expenditures indicate that the item's budget will be full depleted close in time to the end of the budget period (e.g., either before or after the end of the period), the method of FIG. 2 may return to operation 204. Because operations 212 and/or 210 may occur at or near the end of a given time interval (e.g., the end of time interval of time index t in FIG. 3), the return to operation 204 may mark or coincide with initiation of a new time interval.

If the item's bid is to be adjusted in order to alter its win rate and corresponding rate of budget expenditure, the method advances to operation 220. When a budget period ends, the method of FIG. 2 ends.

In operation 220, the win rate estimated to be necessary or sufficient to achieve the pacing goal may be calculated at time t (or during or just after the interval comprising time index t) based on F(t) and R(t). In particular, the current win rate is projected to result in the expenditure of F(t) during the rest of the budget period, but a goal of the pacing scheme is to expend R(t) during that timeframe. Therefore, the current win rate should be increased by a factor equal to

$$\frac{R ( t )}{F ( t )} .$$

This factor, in the scenario of FIG. 3 in which the budget is forecasted to be less than fully depleted by the end of the budget period, is greater than 1.

If the current win rate in effect at time t is represented by WR(t), then the new win rate desired starting with time interval t+1 (or the time interval that includes time index t+1) is

$$WR ( t + 1 ) = WR ( t ) \times \frac{R ( t )}{F ( t )} .$$

It may be noted that this adjustment also applies if the forecast indicates that the budget will be depleted too early if the current win rate continues, in which case the adjustment will involve multiplying the current win rate by a factor that is less than 1.

In operation 222, the new win rate (WR(t+1)) is used to determine a new or adjusted bid for the sponsored content item that should, based on the history of winning eCPI values, yield the new win rate.

In implementations in which winning eCPI values are collected or combined into a histogram, the histogram may be searched (e.g., via a binary search) to find an eCPI that matches WR(t+1) (possibly within some threshold). For example, if the new win rate is 15% (or 0.15), the histogram is searched to find an eCPI that won (approximately) 15% of the auctions encompassed by the histogram—which may illustratively be all auctions within the current or previous time interval. From that eCPI, the new or adjusted bid is calculated as

$$NewBid = \frac{eCPI}{pCTR} ,$$

wherein pCTR is the predicted click-through-rate for the content item.

In implementations in which a distribution of winning eCPI values is generated, that distribution can be analyzed as discussed below to determine how to adjust the sponsored content item's bid in order to support or yield the new win rate.

In operation 224, the new bid is applied starting with the next auction. The method then returns to operation 206, but ends at the end of the current budget period.

Some embodiments of pacing of a sponsored content item described herein are based on the following pacing equation, wherein Spent(t) is the total amount of an item's budget that has been spent as of time interval t (e.g., a time interval that comprises t), Reqs(t) indicates the total number of compatible content requests (e.g., during time interval t or overall), PRate(t) is the pacing rate, or the probability that the item will compete in a given auction associated with a given compatible content request (during time interval t), and WRate(t) is the win rate, or the probability that the item will win an auction in which it participates (during time interval t):

Spent(t)∝Reqs(t)*PRate(t)*WRate(t) (1)

If pacing is applied accurately, then:

Spent(t)=Reqs(t)*PRate(t)*WRate(t) (2)

At any given time t,

$$\frac{dSpent}{dt} = \frac{dReqs}{dt} * PRate ( t ) * WRate ( t ) ,$$

and if actual expenditure of the item's budget is to replicate or approximate the rate of receipt of compatible content requests, the accumulated expenditures can be calculated as follows if the item is served on a CPC basis, for example, wherein pCtr(t) is the predicted click-through-rate at time t or during time interval t:

$$AccSpent ( x ) = {\int }_{0}^{x} \frac{dSpent}{dt} d t ∝ {\int }_{0}^{x} \frac{dReqs * pCtr ( t )}{dt} d t \qquad ( 2 a )$$

From equation (2), one can see that the budget for the following time interval (t+1), which identifies how much of the periodic budget should be spent during that interval, can be represented as:

Budget*+(t+1)=Reqs(t+1)*PRate(t+1)*WRate(t+1) (3)

From equations (1) and (3) representing how much is or should be spent in two consecutive time intervals, we can represent the win rate of the later interval as:

$$WRate ( t + 1 ) = WRate ( t ) * \frac{Budget ( t + 1 )}{Spent ( t )} * \frac{Reqs ( t + 1 )}{Reqs ( t )} * \frac{PRate ( t + 1 )}{PRate ( t )} \qquad ( 4 )$$

As mentioned above, however, in some embodiments PRate is constant throughout a budget period, and may be equal to 1, in which case those terms may be removed. If we define ρ such that

$$ρ = \frac{Budget ( t + 1 )}{Spent ( t )} * \frac{Reqs ( t + 1 )}{Reqs ( t )} ,$$

we can represent equation (4) as:

WRate(t+1)=ρ*WRate(t) (5)

Because the sponsored content item's win rate cannot be adjusted directly, we need to represent the win rate as a function of the item's eCPI, which can be directed adjusted by altering the item's bid.

Therefore, the win rate of the sponsored content item is defined or interpreted as the possibility or probability that the target eCPI (the eCPI that will yield the new/desired win rate for the item) is not less than a randomly selected winning eCPI. Assuming that winning eCPI values (e.g., during the current time interval) are independent and identically distributed, if we randomly select one winning eCPI, the possibility that the target eCPI is not less than that randomly selected eCPI is equal to the percentile of the greatest winning eCPI that is less than the target eCPI.

We then assume that winning eCPI values obey a certain distribution and that the density function of those eCPI values is y(x). Therefore, the percentile of the highest winning eCPI value that is less than the target eCPI is the area under the curve when x≦eCPI(t). The integral ∫₀^{eCPI(t)}γ(x)dx therefore represents the winning rate associated with the target eCPI at time t, and we have:

∫₀^{eCPI(t+1)}γ(x)dx=ρ ∫₀^{eCPI(t)}γ(x)dx (6)

To solve equation (6), we assume that winning eCPI values, or the density of winning eCPI values, obey a log-normal distribution, in which case eCPI˜ln N(μ, σ²).

We then introduce Φ, the Phi function, wherein Φ(x) returns the density of x within a standard normal distribution. Noting that the cumulative distribution function (CDF) of a general normal distribution is equivalent to

$$Φ ( \frac{x - μ}{σ} ) ,$$

and by the definition of a definite integral, we can rewrite equation (6) as

$$Φ ( \frac{ln ( eCPI ( t + 1 ) - μ}{σ} ) - Φ ( \frac{0 - μ}{σ} ) = ρ ( Φ ( \frac{ln ( eCPI ( t ) - μ}{σ} ) - Φ ( \frac{0 - μ}{σ} ) ) \qquad ( 7 )$$

Isolating the term ln (eCPI (t+1) produces

$$ln ( eCPI ( t + 1 ) ) = μ + σ * {Φ}^{- 1} ( ( 1 - ρ ) Φ ( \frac{- μ}{σ} ) + ρΦ ( \frac{ln ( eCPI ( t ) ) - μ}{σ} ) ) \qquad ( 8 )$$

Finally, the target bid (for time interval t+1) is calculated as

$$\frac{eCPI ( t + 1 )}{pCTR} .$$

As indicated above, if a maximum bid has been established, the bid for the sponsored content item may never exceed it. However, in some embodiments, values a and b are applied such that, at any time t, maxBid*a<bid(t)<maxBid*b. Through control of a and b, bid adjustments and resulting pacing can be controlled within an acceptable or desirable range.

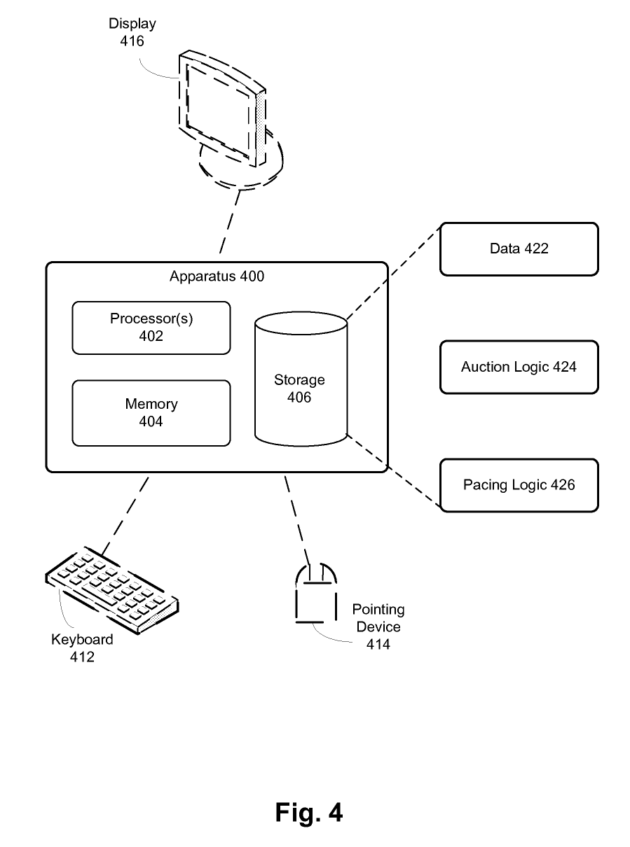

FIG. 4 is a block diagram of an apparatus for pacing the serving of a sponsored content item, according to some embodiments.

Apparatus 400 of FIG. 4 includes processor(s) 402, memory 404, and storage 406, which may comprise one or more optical, solid-state, and/or magnetic storage components. Storage 406 may be local or remote to the apparatus. Apparatus 400 can be coupled (permanently or temporarily) to keyboard 412, pointing device 414, and display 416.

To assist the pacing of the content item, storage 406 and/or memory 404 maintain data 422, which may include a current bid of the item, maximum and/or minimum bids (if set), a periodic budget for the item, accumulated expenditures (during the current period) toward depletion of that budget, an estimated cost per impression of the item, winning eCPI values, a distribution of winning eCPIs, and/or other information.

In addition to data 422, storage 406 also stores logic that may be loaded into memory 404 for execution by processor(s) 402. Such logic includes auction logic 424 and pacing logic 426. In other embodiments, these logic modules may be combined or divided to aggregate or separate their functionality as desired.

Auction logic 424 comprises processor-executable instructions for conducting auctions or competitions between content items, including the sponsored content item, to determine which of them is or are served in response to a content request with which the sponsored content item is compatible. Logic 424 may also, or instead, comprise processor-executable instructions for performing calculations associated with auctions for the purpose of promoting pacing of the sponsored content item. These calculations may include calculating an estimated cost per impression for the item (eCPI) from a bid (and/or vice versa), a ratio of the item's eCPI to the eCPI of the item that won a given auction, which may be termed an estimated cost ratio, combining multiple estimated cost ratios, combining multiple winning eCPI values, maintaining a collection or distribution of estimated cost ratios or winning eCPIs, etc.

Pacing logic 426 comprises processor-executable instructions for pacing the serving of the sponsored content item to promote serving of the item throughout the budget period while fully depleting the budget by the end of the period, within some time-based or value-based thresholds, if applicable. Logic 426 may thus serve to forecast expenditure of a budget at virtually any time within the budget's period (e.g., during some or all of multiple time intervals that form the period), determine whether and how a current win rate of the sponsored content item should be adjusted, determining a new or adjusted bid that can be expected to facilitate the adjusted win rate, and applying the new or adjusted bid (e.g., via auction logic 424).

In some embodiments, apparatus 400 performs some or all of the functions ascribed to one or more components of system 110 of FIG. 1.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method, comprising:
receiving a sponsored first content item;
obtaining an estimated cost of serving the first content item, based on a bid associated with the first content item;
for each of multiple requests to serve electronic content with which the first content item is compatible:
conducting a competition to select one of multiple content items to serve in response to the request, wherein the multiple content items include the first content item; and
recording a winning estimated cost corresponding to the selected content item;
combining multiple winning estimated costs to form a distribution of winning estimated costs during a first time interval in which the requests were received;
identifying a target rate of serving the first content item during a second time interval subsequent to the first time interval; and
based on the distribution of estimated costs, automatically adjusting the bid to promote serving of the first content item at the target rate during the second time interval.

2. The method of claim 1, wherein said combining comprises:
if the quantity of winning estimated costs in the multiple winning estimated costs is less than a threshold, collecting the multiple winning estimated costs, wherein the distribution is the collection of multiple winning estimated costs; and
if the quantity of winning estimated costs in the multiple winning estimated costs is greater than the threshold, determining a normal distribution of the winning estimated costs, wherein the distribution is the normal distribution.

3. The method of claim 1, wherein said identifying comprises:
determining a current win rate of the first content item during the first time interval;
based on the current win rate, calculating a difference between a budget associated with the first content item, wherein the budget encompasses a period of time comprising multiple time intervals, including the first time interval and the second time interval, and total expenditures for the first content item forecasted to result from continuation of the current win rate until the end of the period of time; and
if the difference is greater than a threshold difference, calculating a new win rate such that sustaining the new win rate until the end of the period of time will expend the budget by the end of the period of time, wherein the target rate is the new win rate.

4. The method of claim 3, wherein:
said current win rate is a current rate of expenditure of the budget.

5. The method of claim 3, wherein:
said current win rate is a measure of past requests to serve electronic content in response to which the first content item was served.

6. The method of claim 1, wherein adjusting the bid comprises:
selecting a winning estimated cost, from the distribution of winning estimated costs, such that content items corresponding to the selected winning estimated cost won the competitions at a rate approximately equal to the target rate; and
from the selected winning estimated cost, calculating a corresponding bid.

7. The method of claim 1, further comprising:
repeating said combining, identifying, and adjusting for each of multiple subsequent time intervals.

8. The method of claim 7, wherein not all of the time intervals are of the same duration.

9. The method of claim 1, wherein adjusting the bid comprises setting the bid no higher than a maximum bid provided by the sponsor.

10. An apparatus, comprising:
one or more processors; and
memory storing instructions that, when executed by the one or more processors, cause the apparatus to:
receive a sponsored first content item;
obtain an estimated cost of serving the first content item, based on a bid associated with the first content item;
for each of multiple requests to serve electronic content with which the first content item is compatible:
conduct a competition to select one of multiple content items to serve in response to the request, wherein the multiple content items include the first content item; and
record a winning estimated cost corresponding to the selected content item;
combine multiple winning estimated costs to form a distribution of winning estimated costs during a first time interval in which the requests were received;
identify a target rate of serving the first content item during a second time interval subsequent to the first time interval; and
based on the distribution of estimated costs, automatically adjust the bid to promote serving of the first content item at the target rate during the second time interval.

11. The apparatus of claim 10, wherein said combining comprises:
if the quantity of winning estimated costs in the multiple winning estimated costs is less than a threshold, collecting the multiple winning estimated costs, wherein the distribution is the collection of multiple winning estimated costs; and
if the quantity of winning estimated costs in the multiple winning estimated costs is greater than the threshold, determining a normal distribution of the winning estimated costs, wherein the distribution is the normal distribution.

12. The apparatus of claim 10, wherein said identifying comprises:
determining a current win rate of the first content item during the first time interval;
based on the current win rate, calculating a difference between a budget associated with the first content item, wherein the budget encompasses a period of time comprising multiple time intervals, including the first time interval and the second time interval, and total expenditures for the first content item forecasted to result from continuation of the current win rate until the end of the period of time; and
if the difference is greater than a threshold difference, calculating a new win rate such that sustaining the new win rate until the end of the period of time will expend the budget by the end of the period of time, wherein the target rate is the new win rate.

13. The apparatus of claim 10, wherein adjusting the bid comprises:
selecting a winning estimated cost, from the distribution of winning estimated costs, such that content items corresponding to the selected winning estimated cost won the competitions at a rate approximately equal to the target rate; and
from the selected winning estimated cost, calculating a corresponding bid.

14. The apparatus of claim 10, further comprising:
repeating said combining, identifying, and adjusting for each of multiple subsequent time intervals;
wherein not all of the time intervals are of the same duration.

15. A system, comprising:
an auction module comprising a computer readable medium storing instructions that, when executed, cause the system to,
receive a sponsored first content item;
obtain an estimated cost of serving the first content item, based on a bid associated with the first content item;
for each of multiple requests to serve electronic content with which the first content item is compatible:
conduct a competition to select one of multiple content items to serve in response to the request, wherein the multiple content items include the first content item; and
record a winning estimated cost corresponding to the selected content item; and
combine multiple winning estimated costs to form a distribution of winning estimated costs during a first time interval in which the requests were received; and
a pacing module comprising a computer readable medium storing instructions that, when executed, cause the system to:
identify a target rate of serving the first content item during a second time interval subsequent to the first time interval; and
based on the distribution of estimated costs, automatically adjust the bid to promote serving of the first content item at the target rate during the second time interval.

16. The system of claim 15, wherein said combining comprises:
if the quantity of winning estimated costs in the multiple winning estimated costs is less than a threshold, collecting the multiple winning estimated costs, wherein the distribution is the collection of multiple winning estimated costs; and
if the quantity of winning estimated costs in the multiple winning estimated costs is greater than the threshold, determining a normal distribution of the winning estimated costs, wherein the distribution is the normal distribution.

17. The system of claim 15, wherein said identifying comprises:
determining a current win rate of the first content item during the first time interval;
based on the current win rate, calculating a difference between a budget associated with the first content item, wherein the budget encompasses a period of time comprising multiple time intervals, including the first time interval and the second time interval, and total expenditures for the first content item forecasted to result from continuation of the current win rate until the end of the period of time; and
if the difference is greater than a threshold difference, calculating a new win rate such that sustaining the new win rate until the end of the period of time will expend the budget by the end of the period of time, wherein the target rate is the new win rate.

18. The system of claim 15, wherein adjusting the bid comprises:
selecting a winning estimated cost, from the distribution of winning estimated costs, such that content items corresponding to the selected winning estimated cost won the competitions at a rate approximately equal to the target rate; and
from the selected winning estimated cost, calculating a corresponding bid.

19. The system of claim 15, further comprising:
repeating said combining, identifying, and adjusting for each of multiple subsequent time intervals;
wherein not all of the time intervals are of the same duration.
